(19) United States
(12) Patent Application Publication
(10) Pub. No.: US 2025/0056351 A1
(43) Pub. Date: Feb. 13, 2025

(54) HANDOVER DELAYS IN CELL MOBILITY

(71) Applicant: Nokia Technologies Oy, Espoo (FI)

(72) Inventors: Riikka Karoliina DIMNIK, Espoo (FI); Jani-Pekka KAINULAINEN, Cambridge (GB); Lars DALSGAARD, Oulu (FI)

(21) Appl. No.: 18/769,987

(22) Filed: Jul. 11, 2024

(30) Foreign Application Priority Data
Aug. 7, 2023 (FI) 20235871

(51) Int. Cl. H04W 36/08; H04B 17/318; H04W 36/00

(52) U.S. Cl. CPC H04W 36/08; H04B 17/318; H04W 36/0058; H04W 36/0061

(57) ABSTRACT

A user equipment that is configured to evaluate an expected handover delay to at least one of a plurality of candidate cells and to generate an indication of the handover delay and transmit it to a network node of a serving cell is disclosed. This allows the network to take into account handover delays when deciding on how and whether to perform a handover.

### TECHNOLOGICAL FIELD

Various example embodiments relate to wireless communication systems, and more particularly, to facilitating mobility within such wireless communication systems.

### BACKGROUND

As user equipment (UE) moves through a wireless communication system, it may move through cells that comprise regions of radio coverage that are supported by one or more network access node. Maintaining an ability for a UE to communicate effectively with the wireless communication system as it moves through regions of radio coverage is typically referred to as mobility. There may be latency and potentially an interruption time in coverage associated with moving between cells, and layer 1 or layer 2, sometimes termed lower layer, triggered mobility is being increasingly considered to reduce the latency, overhead and interruption time associated with a UE moving between the different cells.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided an apparatus, comprising: at least one processor; and at least one memory storing instructions that when executed by the at least one processor cause the apparatus at least to perform: evaluating an expected handover delay to at least one of a plurality of candidate cells; generating an indication of said handover delay; and causing transmission of said indication to a network node of a serving cell.

The delay for an apparatus such as a user equipment to handover from a serving cell to a target cell when moving between cells depends on various factors, some of which are specific to the user equipment. Selection of a target cell for a handover is generally performed at the network and the network may not know and may be unable to accurately estimate the handover delay for a particular user equipment. It would be desirable for the network to have some visibility of this information so that a cell where the delay is short or at least within acceptable limits can be preferentially selected as a target cell. Thus, aspects provide for evaluating an expected handover delay for one or more candidate cells and generating and transmitting an indication of one or more of the handover delays to the network.

In some example embodiments, said handover delay is for a lower layer triggered mobility LTM or layer 1/layer 2 L1/L2 triggered mobility handover. L1/L2 triggered mobility handovers are increasingly used to reduce the overhead and latency associated with handovers, thus in L1/L2 mobility it may be particularly advantageous to be aware of handover delays associated with particular UEs when performing the target cell selection.

For the sake of this application LTM and L1/L2 triggered mobility handovers are used interchangeably to mean handovers triggered by lower layer measurements.

In other example embodiments said handover delay is for layer 3 triggered handover. It may also be advantageous to be aware of the handover delay in L3 triggered handovers.

In some example embodiments the apparatus is configured to perform said step of evaluating in response to at least one of the following: receiving a request from a network node; a predetermined point in a cell switch procedure; a signal strength measurement status; or detection of one or more cells.

In some example embodiments, said signal strength measurement status may comprise completion of signal strength measurements, and/or determining one or more signal strength measurements to be greater than a threshold value;

In some example embodiments, the predetermined point in the cell switch procedure may be a point during the performing of measurements associated with a handover before receiving the cell switch command for example during a timing advance acquisition process.

In some example embodiments, the apparatus is caused to perform said step of evaluating in response to receiving a request from said network node, said request being received within at least one of the following: a message indicating a configuration of said candidate cells; a message indicating a cell switch is to be performed; or a separate dedicated request.

The message indicating the configuration of the candidate cells may be an updated configuration following down selection of the candidate cells by the network node.

In some example embodiments, the apparatus is caused to perform said step of evaluating in response to receiving a request from said network, said request indicating said at least one of said plurality of candidate cells for which said evaluating is to be performed.

In some example embodiments, the apparatus is configured to perform said evaluating for a subset of said plurality of candidate cells.

In some example embodiments, said apparatus is configured to: perform said evaluating to a plurality of said plurality of candidate cells, wherein the indication comprises a handover delay to each of said plurality of said plurality of candidate cells and to receive, from the network node in response to the transmitted indication, a handover command triggering a handover to a target cell of said plurality of said plurality of candidate cells, wherein the target cell is associated with the smallest handover delay comprised in the indication.

In some example embodiments, said apparatus is caused to transmit said handover delay indication within at least one of the following: a UE assistance information message; a L1 measurement report; a L3 measurement report; a message indicating configuration of the candidate cells is complete; or a response to a cell switch command.

In some example embodiments, said apparatus is caused to generate said handover delay indication for at least one of the following: each candidate cell; each candidate cell the apparatus has performed measurements on; candidate cells indicated in a request received from said network node; a target cell indicated in a received cell switch command; candidate cells that satisfy at least one predetermined condition, said predetermined condition comprising a handover delay condition or a measurement condition; or at least one candidate cell and a detected cell that is not a candidate cell.

In some example embodiments, said apparatus is caused to cause transmission of said handover delay indication for candidate cells that satisfy at least one predetermined condition, said at least one predetermined condition comprising said handover delay being less than a threshold value.

In some example embodiments, said handover delay indication comprises one of the following: a time delay value; an indication of said delay lying within one of a plurality of predefined ranges of values; an indication that said delay meets or does not meet a threshold value, an index indicative of a value; or an offset value.

The index may index a table of values known to the network and also to the UE. This table may be within the configuration of the system, or it may be a dynamic table that is stored on the network and UE and is updated by reconfiguration messages. The index may be a Boolean value indicating a true or false.

In some example embodiments, said apparatus comprises a user equipment.

According to various, but not necessarily all, example embodiments of the invention there is provided according to one aspect an apparatus, comprising at least one processor; and at least one memory storing instructions that when executed by the at least one processor cause the apparatus at least to perform: causing transmission to a user equipment of a plurality of candidate cell configurations, said plurality of candidate cells being potential target cells for a user equipment to handover to; in response to receipt of at least one indication of an expected handover delay for at least one of said candidate cells, generating a message regarding said handover and causing transmission to said user equipment.

In some example embodiments, said candidate cells comprise candidate cells for a LTM or L1/L2 handover.

In some example embodiments, said message comprises at least one of the following: a modification of said plurality of candidate cell configurations; an indication for said user equipment to perform a layer 3, L3 handover; a cell switch indication; an indication for said user equipment to perform further measurements, or an indication not to perform a handover.

Examples of the further measurements may include layer 1 signal strength measurements and in some cases further delay measurements. Signal strength measurements may be measurements of signal quality and/or signal power and may be based on RSRP received signal to received power measurements for example.

The modification may comprise one of an addition, modification or deletion of candidate cell configurations or it may comprise updated measurement configurations for said candidate cells.

In some example embodiments said cell switch indication indicates a target cell.

In some example embodiments, said apparatus is caused to perform: comparing a value of said at least one expected handover delay with a threshold value; and in response to said comparing generating said message.

In some example embodiments, where said comparing indicates said delay is greater than said threshold value for a candidate cell, said apparatus is caused to perform one of the following: deciding not to trigger a handover to said candidate cell and/or removing said candidate cell as a potential candidate cell.

In some example embodiments, said apparatus is caused to perform: in response to receipt of at least one measurement report indicating signal strengths of at least some of said plurality of candidate cells and to receipt of said evaluation of said handover delays for at least some of said plurality of candidate cells; selecting a target cell from said plurality of candidate cells in dependence upon said handover delays and said measurement reports; and generating said cell switch command as said message, said cell switch command indicating one of said candidate cells as a target cell for a handover.

In some example embodiments, said step of selecting comprises disregarding candidate cells with a handover delay that is greater than said threshold value.

In some example embodiments, said step of selecting comprises for candidate cells where said signal strength measurements are above a threshold value selecting one of said cells having a lowest expected handover delay.

In some example embodiments, said apparatus is caused in response to receipt of said at least one indication of said expected handover delay to perform: forwarding said indication to a central unit network node; and in response to receipt of handover information from said central unit network node generating said message.

In some example embodiments, said apparatus is further caused in response to receipt of at least one measurement report indicating signal strengths of at least some of said plurality of candidate cells to forward said at least one measurement report to said central unit network node.

In some example embodiments the network node is a distributed unit network node and is in communication with a central unit network node may perform the cell selection and the distributing unit may forward the relevant delay and measurement information to the central unit.

In some example embodiments, said apparatus Is caused to perform: generating a message requesting a user equipment to perform an evaluation of a handover delay.

According to various, but not necessarily all, example embodiments of the invention there is provided an apparatus, comprising at least one processor; and at least one memory storing instructions that when executed by the at least one processor cause the apparatus at least to perform: generating a message requesting a user equipment to perform an evaluation of a handover delay.

In some example embodiments, said message comprises one of the following: a message indicating a configuration of said candidate cells; a message indicating a cell switch is to be performed; or a separate dedicated request.

In some example embodiments, said apparatus comprises a network node, such as a distributed unit of a gNB or a base station.

According to various, but not necessarily all, example embodiments of the invention there is provided according to one further aspect, an apparatus comprising at least one processor; and at least one memory storing instructions that when executed by the at least one processor cause the apparatus at least to perform: in response to receipt of at least one indication of an expected handover delay of a user equipment received from a distributed unit network node generating handover information; and causing transmission to a distributed unit network node

In some example embodiments, said apparatus is caused to perform: comparing a value of said at least one expected handover delay with a threshold value; and in response to said comparing generating said handover information.

In some example embodiments, in response to receipt of at least one measurement report indicating signal strengths of at least some of said plurality of candidate cells and to receipt of said evaluation of said handover delays for at least some of said plurality of candidate cells, said apparatus is caused to perform: selecting a target cell from said plurality of candidate cells in dependence upon said handover delays and said measurement reports; and transmitting of an indication of said target cell to said distributed unit as said handover information

In some example embodiments, said apparatus is further caused to perform: transmitting of an indication of said handover to a selected target cell.

In some example embodiments, said apparatus comprises a network node such as a central unit network node of a gNB.

According to various, but not necessarily all, example embodiments of the invention there is provided a network node comprising at least one apparatus according to one aspect, said apparatus comprising a distributed unit of said network node and an apparatus comprising a central unit of said network node according to one further aspect.

According to various, but not necessarily all, example embodiments of the invention there is provided, a method performed by an apparatus, said method comprising: evaluating an expected handover delay to at least one of a plurality of candidate cells; generating an indication of said handover delay; and transmitting said indication to a network node of a serving cell.

In some example embodiments the step of evaluating is performed in response to at least one of the following: receiving a request from a network node; a predetermined point in a cell switch procedure; a signal strength measurement status; or detection of one or more cells.

In some example embodiments, the step of evaluating is performed in response to receiving a request from said network node, said request being received within at least one of the following: a message indicating a configuration of said candidate cells; a message indicating a cell switch is to be performed; or a separate dedicated request.

In some example embodiments, the step of evaluating is performed in response to receiving a request from said network said request indicating said at least one of said plurality of candidate cells for which said evaluating is to be performed.

In some example embodiments, said step of evaluating is performed for one of the following: one, a subset or all of said plurality of candidate cells.

In some example embodiments, said step of evaluating is performed to a plurality of said plurality of candidate cells, wherein the indication comprises a handover delay to each of said plurality of said plurality of candidate cells and said method comprises receiving, from the network node in response to the transmitted indication, a handover command triggering a handover to a target cell of said plurality of said plurality of candidate cells, wherein the target cell is associated with the smallest handover delay comprised in the indication.

In some example embodiments, said method comprises transmitting said handover delay indication within at least one of the following: a UE assistance information message; a L1 measurement report; a L3 measurement report; a message indicating configuration of the candidate cells is complete; or a response to a cell switch command.

In some example embodiments, said method comprises generating said handover delay indication for at least one of the following: each candidate cell; each candidate cell the apparatus has performed measurements on; candidate cells indicated in a request received from said network node; a target cell indicated in a received cell switch command; candidate cells that satisfy at least one predetermined condition, said predetermined condition comprising a handover delay condition or a measurement condition; or a detected cell that is not a candidate cell.

In some example embodiments, said method comprises transmitting said handover delay indication for candidate cells that satisfy at least one predetermined condition, said at least one predetermined condition comprising said handover delay being less than a threshold value.

According to various, but not necessarily all, example embodiments of the invention there is provided, a method performed by an apparatus, said method comprising transmitting to a user equipment of a plurality of candidate cell configurations, said plurality of candidate cells being potential target cells for a user equipment to handover to; receiving at least one indication of an expected handover delay for at least one of said candidate cells, and generating a message regarding said handover; and transmitting said message to said user equipment.

In some example embodiments, said method comprises comparing a value of said at least one expected handover delay with a threshold value; and in response to said comparing generating said message.

In some example embodiments, said method comprises, where said comparing indicates said delay is greater than said threshold value for a candidate cell, deciding not to trigger a handover to said candidate cell and/or removing said candidate cell as a potential candidate cell.

In some example embodiments, said method comprises: receiving at least one measurement report indicating signal strengths of at least some of said plurality of candidate cells and to receipt of said evaluation of said handover delays for at least some of said plurality of candidate cells; selecting a target cell from said plurality of candidate cells in dependence upon said handover delays and said measurement reports; and generating said cell switch command as said message, said cell switch command indicating one of said candidate cells as a target cell for a handover.

In some example embodiments, said step of selecting comprises disregarding candidate cells with a handover delay that is greater than said threshold value.

In some example embodiments, said step of selecting comprises for candidate cells where said signal strength measurements are above a threshold value selecting one of said cells having a lowest expected handover delay.

in some example embodiments, said method comprises receiving at least one indication of said expected handover delay and forwarding said indication to a central unit network node; receiving handover information from said central unit network node and generating said message.

In some example embodiments, said method comprises receiving at least one measurement report indicating signal strengths of at least some of said plurality of candidate cells and forwarding said at least one measurement report to said central unit network node.

In some example embodiments, said method comprise generating a message requesting a user equipment to perform an evaluation of a handover delay.

According to various, but not necessarily all, example embodiments of the invention there is provided a method comprising generating a message requesting a user equipment to perform an evaluation of a handover delay.

According to various, but not necessarily all, example embodiments of the invention there is provided, a method performed at an apparatus, said method comprising: receiving from a distributed unit of a network node at least one indication of an expected handover delay of a user equipment, generating handover information and transmitting said handover information to said distributed unit network node.

In some example embodiments, said method comprises comparing a value of said at least one expected handover delay with a threshold value; and in response to said comparing generating said handover information.

In some example embodiments, receiving at least one measurement report indicating signal strengths of at least some of said plurality of candidate cells and selecting a target cell from said plurality of candidate cells in dependence upon said handover delays and said measurement reports; and transmitting an indication of said target cell to said distributed unit

In some example embodiments, said method comprises transmitting of an indication of said handover to a selected target cell.

According to various, but not necessarily all, example embodiments of the invention there is provided an apparatus comprising: means for evaluating an expected handover delay to at least one of a plurality of candidate cells; means for generating an indication of said handover delay; and means for transmitting said indication to a network node of a serving cell.

In some example embodiments said apparatus comprises means for receiving a request from a network node.

According to various, but not necessarily all, example embodiments of the invention there is provided, an apparatus comprising means for transmitting a plurality of candidate cell configurations to a user equipment, said plurality of candidate cells being potential target cells for a user equipment to handover to; means for receiving at least one indication of an expected handover delay for at least one of said candidate cells, and means for generating a message regarding said handover for transmission to said user equipment.

In some example embodiments, said apparatus comprises means for comparing a value of said at least one expected handover delay with a threshold value.

In some example embodiments, said apparatus comprises means for selecting a target cell from said plurality of candidate cells in dependence upon said handover delays and said measurement reports.

In some example embodiments, said apparatus comprises means for generating a message requesting a user equipment to perform an evaluation of a handover delay.

According to various, but not necessarily all, example embodiments of the invention there is provided an apparatus comprising means for generating a message requesting a user equipment to perform an evaluation of a handover delay.

According to various, but not necessarily all, example embodiments of the invention there is provided, an apparatus comprising: means for receiving from a distributed unit of a network node at least one indication of an expected handover delay of a user equipment, means for generating handover information and means for transmitting said handover information to said distributed unit network node.

In some example embodiments, said apparatus comprises means for comparing a value of said at least one expected handover delay with a threshold value; and in response to said comparing said means for generating said handover information.

In some example embodiments, said apparatus comprises means for selecting a target cell from said plurality of candidate cells in dependence upon said handover delays and said measurement reports; and transmitting an indication of said target cell to said distributed unit.

The means may perform the optional features set out in relation to the apparatus mentioned above.

According to various, but not necessarily all, example embodiments of the invention there is provided an apparatus comprising: circuitry configured to evaluate an expected handover delay to at least one of a plurality of candidate cells; circuitry configured to generate an indication of said handover delay; and a transmitter for transmitting said indication to a network node of a serving cell.

In some example embodiments said apparatus comprises a receiver for receiving a request from a network node.

According to various, but not necessarily all, example embodiments of the invention there is provided, an apparatus comprising a transmitter configured to transmit a plurality of candidate cell configurations to a user equipment, said plurality of candidate cells being potential target cells for a user equipment to handover to; a receiver configured to receive at least one indication of an expected handover delay for at least one of said candidate cells, and generating circuitry configured to generate a message regarding said handover for transmission to said user equipment.

In some example embodiments, said apparatus comprises comparing circuitry configured to compare a value of said at least one expected handover delay with a threshold value.

In some example embodiments, said apparatus comprises selecting circuitry configured to select a target cell from said plurality of candidate cells in dependence upon said handover delays and said measurement reports.

In some example embodiments, said apparatus comprises generating circuitry configured to generate a message requesting a user equipment to perform an evaluation of a handover delay.

According to various, but not necessarily all, example embodiments of the invention there is provided an apparatus comprising generating circuitry configured to generate a message requesting a user equipment to perform an evaluation of a handover delay.

According to various, but not necessarily all, example embodiments of the invention there is provided, an apparatus comprising: a receiver for receiving from a distributed unit of a network node at least one indication of an expected handover delay of a user equipment, generating circuitry configured to generate handover information and a transmitter for transmitting said handover information to said distributed unit network node.

In some example embodiments, said apparatus comprises comparing circuitry configured to compare a value of said at least one expected handover delay with a threshold value; and in response to said comparing said generating circuitry is configured to generate said handover information.

In some example embodiments, said apparatus comprises selecting circuitry configured to select a target cell from said plurality of candidate cells in dependence upon said handover delays and said measurement reports; said transmitter being configured to transmit an indication of said target cell to said distributed unit.

The circuitry may be configured perform the optional features set out in relation to the apparatus mentioned above.

According to various, but not necessarily all, example embodiments of the invention there is provided a computer program comprising computer readable instructions which when executed by at least one processor on an apparatus are operable to control said apparatus to perform at least the following: evaluating an expected handover delay to at least one of a plurality of candidate cells; generating an indication of said handover delay; and causing transmission of said indication to a network node of a serving cell.

According to various, but not necessarily all, example embodiments of the invention there is provided a computer program comprising computer readable instructions which when executed by at least one processor on an apparatus are operable to control said apparatus to perform at least the following: causing transmission to a user equipment of a plurality of candidate cell configurations, said plurality of candidate cells being potential target cells for a user equipment to handover to; in response to receipt of at least one indication of an expected handover delay for at least one of said candidate cells generating a message regarding said handover for transmission to said user equipment.

According to various, but not necessarily all, example embodiments of the invention there is provided computer program comprising computer readable instructions which when executed by at least one processor on an apparatus are operable to control said apparatus to perform at least the following: in response to receipt from a distributed unit of a network node at least one indication of an expected handover delay of a user equipment generating handover information; and causing transmission of said handover information to said distributed unit of said network node.

According to various, but not necessarily all, example embodiments of the invention there is provided a non-transitory computer readable medium comprising program instructions stored thereon for performing at least the following:
evaluating an expected handover delay to at least one of a plurality of candidate cells;
generating an indication of said handover delay; and causing transmission of said indication to a network node of a serving cell.

According to various, but not necessarily all, example embodiments of the invention there is provided a non-transitory computer readable medium comprising program instructions stored thereon for performing at least the following: causing transmission to a user equipment of a plurality of candidate cell configurations, said plurality of candidate cells being potential target cells for a user equipment to handover to; in response to receipt of at least one indication of an expected handover delay for at least one of said candidate cells generating a message regarding said handover for transmission to said user equipment.

According to various, but not necessarily all, example embodiments of the invention there is provided a non-transitory computer readable medium comprising program instructions stored thereon for performing at least the following: in response to receipt from a distributed unit of a network node at least one indication of an expected handover delay of a user equipment generating handover information; and causing transmission of said handover information to said distributed unit of said network node.

The instructions may be for performing the optional features set out in relation to the method mentioned above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

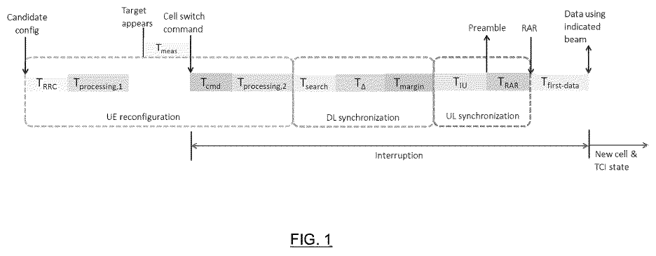

FIG. 1 schematically illustrates the different components of mobility latency that may contribute to a handover delay;

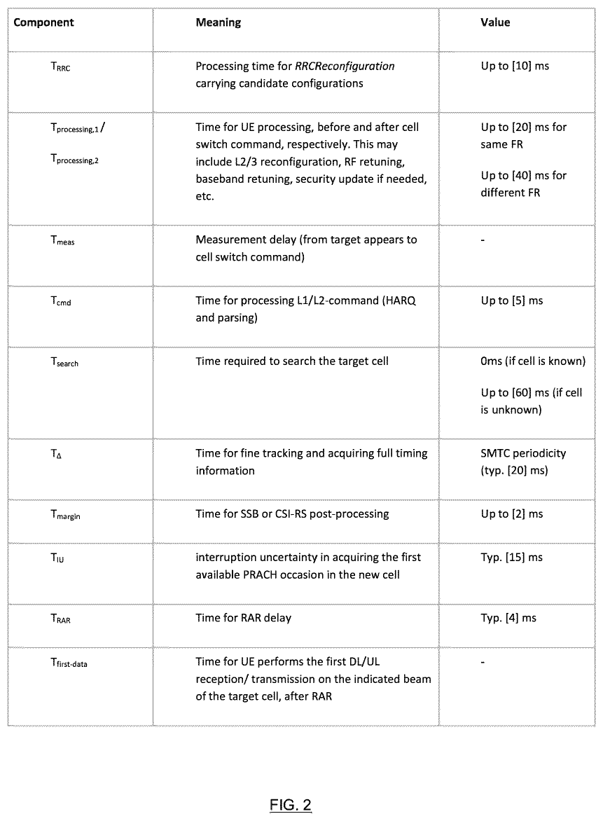

FIG. 2 provides further details of the different components of FIG. 1;

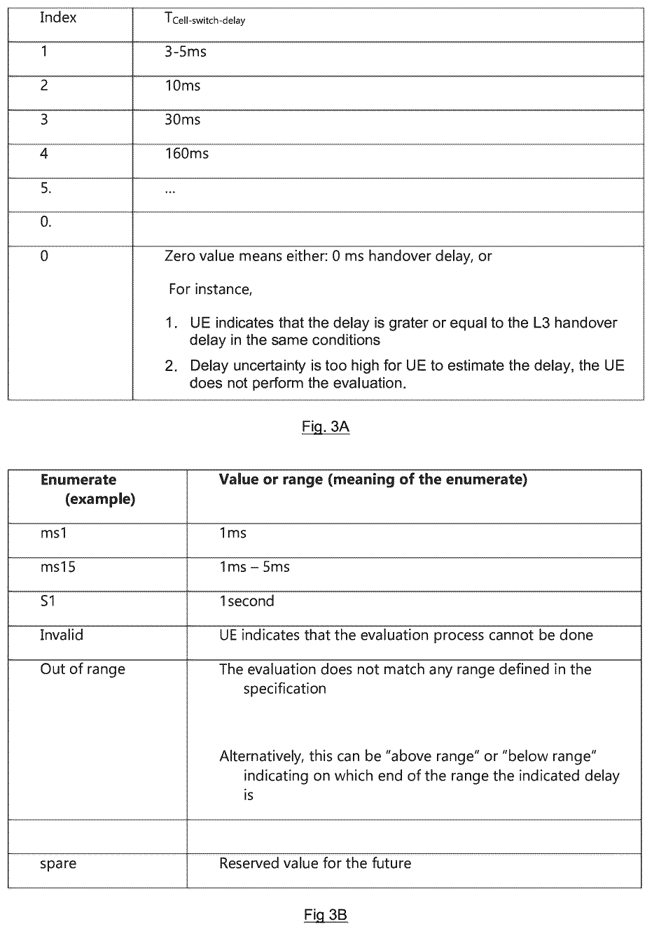

FIG. 3A provides an example of index mapping to a handover delay table according to an example embodiment;

FIG. 3B provides an example of an enumerate value mapping table according to an example embodiment;

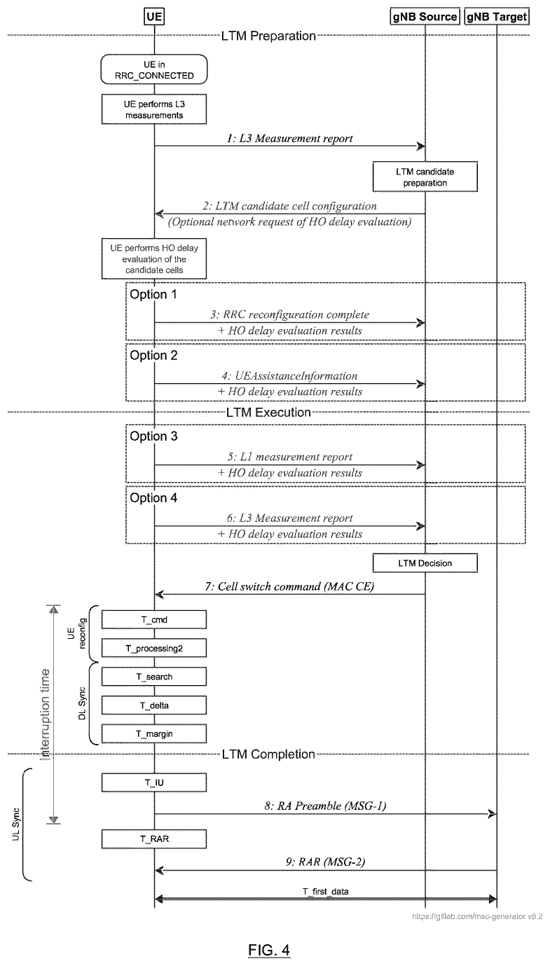

FIG. 4 provides a signalling diagram of an example embodiment;

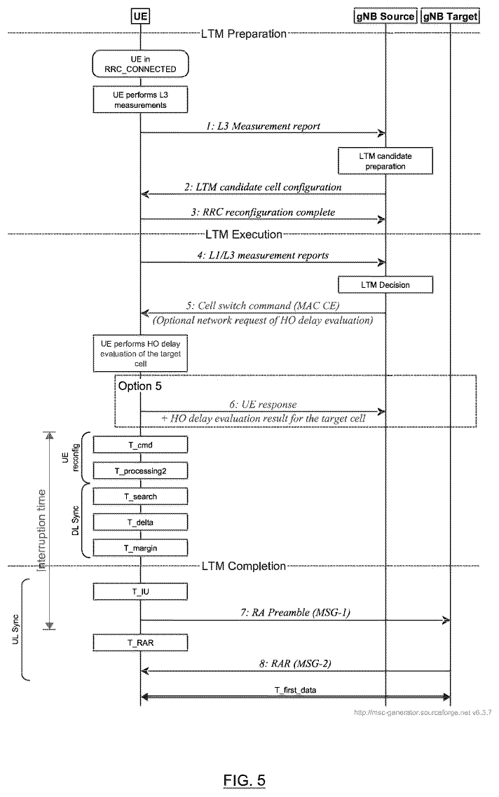

FIG. 5 provides a signalling diagram of another example embodiment;

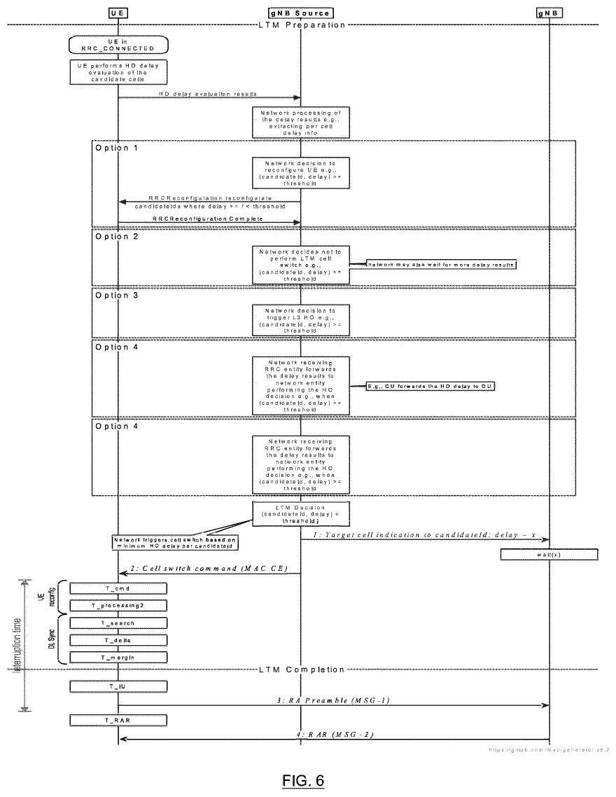

FIG. 6 provides a signalling diagram of another example embodiment showing different options for signalling at the network node; and

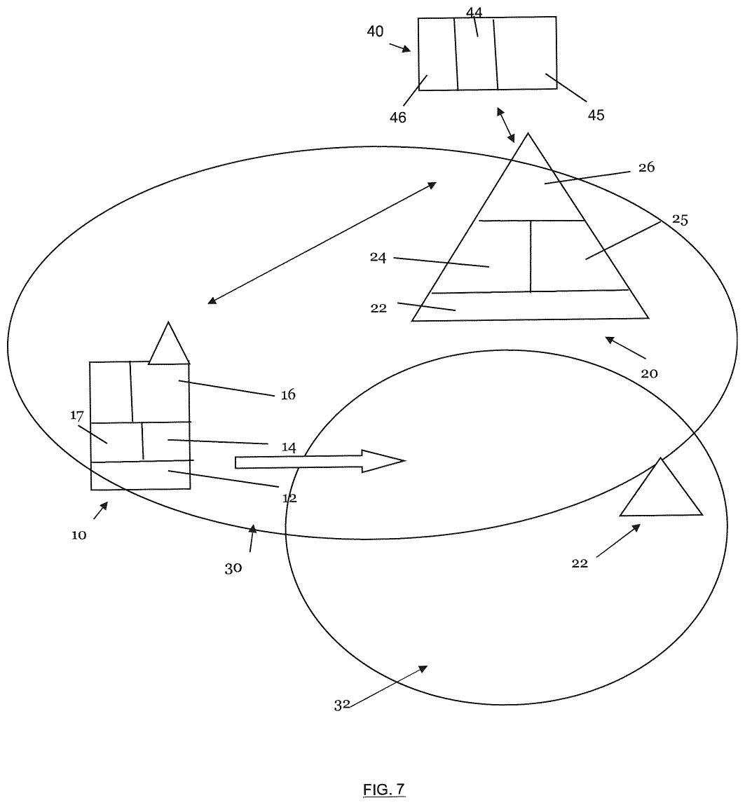

FIG. 7 schematically illustrates a communication network according to an example embodiment.

### DETAILED DESCRIPTION

Before discussing the example embodiments in any more detail, first an overview will be provided.

During user equipment UE mobility, the delay for handing over to different candidate cells may vary depending on e.g., whether the target cell is known or whether intra- or inter-frequency handover is to be performed. Some UEs may also be able to perform some steps of the handover faster than other UEs.

RAN4 defined minimum requirements, which consider the worst-case (longest) requirements. In the scenarios where a UE can outperform these requirements the expected handover delay is not visible to the network before the UE sends random access preamble on the target cell. In RACH-less L1/L2 handover, the network does not know when the UE is ready to be scheduled on the target cell since there is no clear ending point for the handover unlike in RACH-based HO, where the random-access preamble transmission is defined as the ending point for the handover. Many of the delay components (shown in FIG. 1) in such a handover are not visible to the network. i.e., the network may not exactly know the expected handover interruption time when the decision to trigger a cell switch/handover takes place.

Providing information regarding expected handover delay for candidate cells to a network node may enable the network node to improve its handover decisions and potentially reduce handover latency.

L1/L2 triggered mobility has been introduced to reduce latency compared to conventional higher layer handovers and where the estimated expected handover delay for a candidate cell is long then it may be advantageous for the network node not to trigger a handover to that cell or to trigger a L3 handover. The delay assistance information may also be used in an L3 handover process. In the context of the present description, the term ‘handover’ HO is intended to cover both L1/L2 cell switch and L3 handover, unless otherwise specified. Embodiments described herein are thus applicable to both L3 handovers and L1/L2 cell switches.

In summary embodiments provide expected handover information to the network allowing the network to consider the expected handover delay estimated by the UE as an input to cell switch/handover decision.

In example embodiments, the following steps may be used:
1) UE evaluates the expected handover delay to candidate cells and signals this to the network.

This may be done for all or a subset of the candidate cells, even to only a single candidate cell.
2) Upon receiving this handover indication, the network decides whether to:
   a) to perform a cell switch to an indicated cell. If the expected interruption or handover delay is less than a threshold (delay threshold) and associated signal strength measurements indicate signal strength above another threshold (signal strength threshold), the network triggers a cell switch. For this purpose, the UE may report the measured signal strength(s), according to the state of the art.
   b) to provide UE with candidate cell reconfiguration, e.g., add, modify, delete candidate cells/measurement configurations.
   c) to request more measurements from the UE or trigger measurements.

The delay assistance information may also apply to L3 handover.

With the method of example embodiments, the network can estimate the expected handover interruption or delay time when the decision to trigger a cell switch/handover is to be performed. In dependence upon the expected handover interruption/delay time the network may decide not to trigger a cell switch/handover in case the interruption time is too high and instead to add, modify, delete candidate cells/measurement configurations or to request more measurements.

With this method it is possible to allow L1/L2 handover only if the interruption to data transmission is shorter than a certain threshold and the requirement that L1/L2 handover causes a shorter interruption to data transmission than traditional L3 handover can be met.

The UE may perform one or more of the following:
1) Receiving a request from the network to evaluate and send to the network the expected HO delay for all or a subset of the candidate cells.
2) Evaluating the expected HO delay to each or a subset of candidate cells.
3) Reporting an indication of the expected HO delay to the network in one or more of the following: L1 measurement report, L3 measurement report or another message.

The network node may perform one or more of the following:
1) Receiving the delay information from UE.
2) Comparing the delay to a threshold. If the delay value is less, equal, or greater than the threshold, the network either triggers or does not trigger a subsequent action such as:
   a) The network modifies the candidate cell list based on the delay values indicated and triggers RRCReconfiguration message to add/modify/delete candidate cells or modifies the measurement configuration.
   b) The network decides not to perform the cells switch on indicated candidate cell, but waits for UE to transmit subsequent measurement or HO delay values.
   c) The network decides to trigger L3 handover instead of LTM when the delay exceeds a threshold.
   d) The network forwards the delay information to the entity performing HO decision.
   e) The network triggers cell switch on candidate cell when delay is less than or equal to a threshold value.

In current commercially available 3GPP systems mobility and handover (HO) is carried out using RRC signalling. A reason for this is due to the robustness of the RRC signalling which helps ensure that any loss of HO related signalling is minimized or at least reduced and therefore also minimizes or reduces the HO failures due to signalling failures. Legacy HO's are based on using L3 measurements only. The results of these measurements are then sent by the UE to the network using RRC signalling in measurement reports. Based on these L3 measurement results sent in the measurement reports, the network may decide to HO the UE from one cell to another cell. One aspect with existing L3 HO solution is that it has been claimed to sometimes introduce a delay which is causing some challenges in certain scenarios.

As part of the Further NR Mobility Enhancements work item, 3GPP is specifying mechanism and procedures of L1/L2 based inter-cell mobility for mobility latency reduction. LTM or L1/L2 based mobility is a procedure where the UE is changing cells based on L1/L2 triggered command. The UE is configured with a number of candidate cells using RRC configuration. In LTM, the network receives L1 measurement reports from UEs, and performs changes on UEs' serving cell(s) by a cell switch command (e.g., MAC control element, i.e., MAC CE). The MAC CE is used to indicate previously signalled LTM candidate cell (e.g., cell id), and candidate cell configuration associated with the particular cell switch command.

LTM currently applies for UEs in NR connected mode. However, the procedure may also apply to other states and system like 6G in the future. The current design of the LTM procedure based on latest RAN1 and RAN2 agreements can be summarized in the following steps:
1. A LTM capable UE is connected to a cell (serving cell) and is performing L3 measurements on one or more neighbouring cells.
2. Network provides to the UE through RRC message a LTM candidate cell configuration comprising of one or multiple LTM candidate cells.
3. UE performs L1 measurements on the configured candidate cells and reports the results to the network.
4. Based on the UE reported L1 measurement results, the network may configure the UE to activate one or more TCI states with MAC CE for one or multiple candidate cells before the cell switch command. Alternatively, TCI state is activated at the cell switch command.
5. From the one or more activated LTM candidate cells, the network may select one of the LTM candidate cells as the target cell and request the UE to switch cell using a MAC-CE LTM cell switch command to the UE to have the UE to execute the LTM handover to the target cell.
   The cell switch command comprises (at least) of:
      The index of LTM candidate target configuration to apply for LTM cell switch
      Indication (and possibly activation if not done before the cell switch as in step 4) DL and UL (or joint) TCI state ID for the LTM target cell
      DL and UL BWP ID
6. UE detaches from the source cell and LTM handover is completed to the target cell.

### Optional/Additional Steps:

As an additional or optional step, the network may request the UE to prepare UL synchronization to the potential LTM target cell. This step may be executed between steps 4 and 5 above.

To prepare one or multiple LTM candidate cells, the network may initiate PDCCH ordered random access on one or multiple candidate cells before the network request the actual LTM cell switch to the target cell(s).

On the potential LTM target cell, using RACH, the UE may send preamble to enable network to acquire the UL timing, timing advance (TA) value, of the target cell before the cell switch command.

However, UL synchronization may also be executed after the LTM cell switch, for example if early TA acquisition has not been performed by PDCCH order before the cell switch command.

### Handover Delay

RAN4 has defined handover delay for L3 handover and its different options in section 6 of TS 38.133. In the work item for Further NR Mobility Enhancements (RP-223520), 3GPP is defining L1/L2 based inter-cell mobility (LTM), which is a lower layer based handover, for which RAN4 is defining LTM HO delay requirements.

In the existing L3 HO requirements, handover delay may depend on different factors e.g. whether the target cell is known or unknown and whether the HO is to an intra-frequency or inter-frequency target cell. Some of these conditions are visible to the network, but the network does not for example know whether a candidate cell is known to the UE, or the current radio conditions leading potentially to different measurement times.

Furthermore, the defined HO delay in TS 38.133 is a minimum requirement, and some UEs may be able to complete some steps of the delay faster than others. This fact is addressed in the L3 HO scenario by having UE transmit preamble on the PRACH (physical radio access channel) in the target once the UE has switched to the target cell and is ready to transmit. I.e. the network knows the UE is ready to transmit/receive on the new cell when it sends PRACH on that cell. When exactly this happens is not known to the network before the PRACH is sent.

The values for the parameters related to the handover interruption time are defined for different source-target cell combinations and depend e.g. on
1. whether the handover is intra-frequency or inter-frequency,
2. whether the target cell is known or unknown,
3. whether the source/target cell is in FR1 or FR2 (frequency range1/2),
Separate requirements are defined for inter-RAT (radio access handovers), NR DAPS (new radio dual access protocol stacks) handover, NR conditional handover and NR handover with PSCell (primary secondary cell).

The delay for LTM handover is not defined by RAN4 yet, but the components of the delay are initially captured in a running CR by RAN2 (R2-2213332). Although the details of the delay are not agreed yet, the goal may be that LTM handover would cause a shorter interruption to data transmission than traditional L3 handover.

FIG. 1 schematically shows the different components that may contribute to a handover delay for LTM or L1/L2-based inter-cell mobility.

The HO delay or interruption time for L1/L2-based inter-cell mobility may be considered to be the time from the UE receiving the cell switch command to the UE performing the first DL/UL reception/transmission on the indicated beam of the target cell.

TRRC is the Processing time for RRCReconfiguration carrying candidate configurations.

Tprocessing, 1/Tprocessing,2 is the Time for UE processing, before and after cell switch command, respectively.

Tmeas is the Measurement delay (from target appears to cell switch command).

Tcmd is the Time for processing L1/L2-command (HARQ-hybrid automatic repeat request and parsing).

Tsearch is the Time required to search the target cell.

TΔ is the Time for fine tracking and acquiring full timing information.

Tmargin is the Time for SSB or CSI-RS post-processing.

TIU is the interruption uncertainty in acquiring the first available PRACH occasion in the new cell.

TRAR is the Time for RAR (random access response) delay.

Tfirst-data is the Time for UE performs the first DL/UL reception/transmission on the indicated beam of the target cell, after RAR.

There may be other sources of delay in some embodiments, for example FFS if TRS tracking after HO and CSI RS measurement should also be included, i.e. the time to use a high-performance beam.

FIG. 2 shows a table describing in more detail the different components of mobility latency shown in FIG. 1 along with typical time values.

UE may perform delay (e.g., T_{delay}) evaluation by associating a static or dynamic delay value with a process or processes which are triggered by the cell switch In one implementation example, the delay association is done beforehand. For instance, UE has been configured (either internally by the UE or network) with a static lookup table which describes delays and conditions associated with the Tdelay or any of the sub-components needed (e.g., MAC CE processing), RF retuning, baseband retuning, cell search time. The association may be based on UE internal process identifier association, or times that are known statically. For instance, when processing doesn't have a dynamic component, or when processing never exceeds a value (and to have benefit, the value is still less than the value defined in minimum requirements). The evaluated delay may depend a lot on the UE, but in the evaluation the UE may use e.g. the knowledge of whether the cell is known (detectable, measured, . . . ), how many cells the UE is currently measuring and what the radio conditions are, whether the cell is an intra- or inter-frequency or -TRP cell. Once the delay request is triggered by UE or network, UE evaluates the received command(s), radio-, and processing conditions, and fetches a corresponding value from the lookup table that matches with the static (e.g., known processing, known memory interaction, delays) dynamic conditions (e.g., dynamic radio condition related or processing, memory related values) UE is in. For example, UE has a lookup table including an association of each possible MAC CE value with an integer value [{MAC CE cell switch 1, delay 1 ms}, {MAC CE cell switch 2, delay 2 ms}, . . . ] Upon receiving MAC CE cell switch 2, and once identified, the UE reads the lookup table delay value 2 ms and adds this into a total (Tdelay) delay calculation. This delay can be smaller than or equal to the minimum requirements, and therefore, the total, indicated interruption delay may be smaller than the minimum requirements. Similarly, different processes associated with the interruption delay, and defined by minimum requirements can be split into values from which UE collects and sums a total or split delay value.

In summary, RAN4 discussions have agreed the following regarding LTM cell switch delay:
RACH-based Cell switch delay T_{delay} for Pcell/PSCell may have the following components:
T_{delay}=T_{cmd}+T_{processing}/T_{LTM}_{^{−}}_{processing}+T_{search}+T_{Δ}+T_{margin}+T_{uncertainity}/T_{IU}, where T_{uncertainity}/T_{IU} is the uncertainty in acquiring the first available PRACH occasion in the new cell.

Note: ‘/’ means ‘or’ here.

While RACH-less Cell switch delay for Pcell/PSCell may have the following components:
T_{delay}=T_{cmd}+T_{processing,2}/T_{LTM}_{^{−}}_{processing}+T_{search}+T_{Δ}+T_{margin}+T_{uncertainity}/T_{IU},
Note: ‘/’ means ‘or’ here.

T_{cmd} equals to T_{HARQ}+3 ms, where T_{HARQ} is the timing between cell switch command and acknowledgement as specified in TS 38.213.

The values of each parameter in the agreed equations have not been agreed by RAN4#107 meeting for any other parameter than Tcmd, however, it is expected that the values may differ in a similar manner as in the L3 handover requirements, or there may be even more variation, based on at least:
1. Target cell frequency range
2. Target cell being a neighbouring cell or a current serving cell
3. Whether the target cell is intra-frequency or inter-frequency cell
4. How much of the processing of the candidate cell configuration has been done before the cell switch command
5. Whether TCI state activation has been done before the cell switch command or is done at the cell switch command
6. Whether RACH is done before or after the cell switch

The end point of the LTM handover is not yet agreed by RAN4. In RACH-based cell switch, the UE will send PRACH on the target cell at the end of the interruption similar as in L3 handover, and that can be assumed to be the ending point of the handover. However, in RACH-less case it is not clear when the handover is completed, so the network may not know when it can expect the UE is ready to be scheduled. RAN4 is still discussing what is defined to be the ending point for the RACH-less case.

As mentioned above, the delay for handing over to different candidate cells may be different depending on e.g. whether the target cell is known or whether intra- or inter-frequency handover is in question. Some UEs may also be able to perform some steps of the handover faster than others, so each UE may have different processing capabilities. Furthermore, the radio conditions may affect the delay. In the estimating of the handover delay for a candidate cell, the UE may thus take into account at least some of the following characteristics: whether or not the candidate cell is known (detected by the UE, measured by the UE), how many candidate cells the UE is currently measuring, the radio conditions, whether the handover to the candidate cell is an intra-frequency handover or an inter-frequency handover. Different UEs may have different handover delays under the same or substantially similar conditions depending on the hardware and software configurations, and tolerances in the production and testing, for example. Therefore, each UE may measure the handover delays under the different conditions and store them for reporting according to the embodiments described herein. RAN4 defines minimum requirements, which means the delays consider the worst case (longest delay) requirements. Therefore, in the scenarios where UE can outperform the requirements, the expected handover delay is not visible to the network before the UE actually sends random access preamble on the target cell.

Furthermore, in RACH-less LTM handover, the network does not know when the UE is ready to be scheduled on the target cell since there is no clear ending point for the handover similarly as in RACH-based HO, where the random access preamble transmission is defined as the ending point for the handover. Depending on the scenario, it is only known, and visible to the UE how long it takes to perform a cell switch (or a handover) hand over to a target cell.

To address the issues outlined above and to help enable visibility of the expected handover/cell switch delay to the network especially in RACH-less handover scenario (but not excluding RACH-based scenario), the following is proposed: The UE evaluates the expected handover delay to candidate cells and signals this to the network.

The evaluation and indication of the handover delay can be done for:
All candidate cells
Candidate cells the UE has measured (L1 and/or L3 measurements)
For a subset of candidate cells based on network request or a configuration, or some other criteria
   The indication can be done in:
L1 measurement report
L3 measurement report
A separate existing or new message (e.g., UE assistance information)
Control information, such as MAC CE or UCI
   The indication can be a one-time indication or a dynamic indication that is sent under specific conditions.
   Upon receiving this indication, the network
Considers the indicated handover delay(s) as an input to a handover decision process
   If the handover is L1/L2 triggered, DU (distributed unit of network node gNB) considers the information either by reading the indication (L1-measurement, MAC CE, UCI, or receives a message from the CU (central unit of the gNB) which indicates the UE delay).
The network entity performing the handover decision will then
   Decide whether to perform a cell switch to an indicated cell
      if interruption delay is less than a delay threshold and associated signal strength measurements are above a signal strength threshold, the network triggers a cell switch.
      Network may transmit an indication to the target cell indicating the handover delay. This may be done either by the deciding entity transmitting the signal, or by a central entity (e.g., CU). The target entity may then expect UE to be handed over to the particular cell within the delay specified.
   Decide whether to perform candidate cell reconfiguration to the UE
      E.g, add, modify, delete candidate cells
      E.g., add, modify, delete measurement configurations
   Decide whether to request more measurements from the UE or trigger measurements.

In an embodiment, the UE performs the evaluation to certain candidate cells, e.g. to all candidate cells or to a subset of candidate cells. Then, the UE transmits said handover delay indication for a first subset of these candidate cells that satisfy at least one predetermined condition. The at least one predetermined condition may comprise said handover delay being less than a threshold value, e.g. a predefined minimum delay. The UE may exclude from said handover delay indication a second subset of these candidate cells that do not satisfy said predetermined condition of said handover delay being less than the threshold value. The first subset may include multiple indicated candidate cells. As described above, the network entity may then select a target cell for the handover among the indicated candidate cells, e.g. the candidate cell associated with the smallest handover delay or the candidate cell associated with the smallest handover delay that also provides the signal strength above the respective signal strength threshold.

In addition to performing the evaluation to certain candidate cells, the UE may also perform the evaluation to a detected cell that is not a candidate cell. This may be the case, where the cell is recently detected by the UE but has not been indicated to be a candidate cell by the network. The UE may transmit a handover delay indication for this detected cell as well as for one or more candidate cells.

In the following, LTM handover is used as an example, but the proposed solution can also be used for other handover types.

In embodiments, the handover and cell switch are used interchangeably as the delay assistance information may also apply to L3 handover.

Using LTM as a baseline mobility scenario, the following steps may be used to in embodiments:
1. In some embodiments: When/after signalling the UE a LTM candidate cell configuration, network requests the UE to evaluate and send to the network the expected handover delay for all or a subset of the candidate cells.
   Network may send the request in the LTM candidate cell configuration, cell switch command or another existing or new message.
   In one alternative, the network may send the request under some condition e.g. based on UE reported L1 or L3 measurement results.
   The request may consider all or a subset of candidate cells.
2. UE evaluates the expected HO/LTM cell switch delay to each or a subset of candidate cells.
   The evaluation may be performed as a default at a predefined point of the cell switch procedure, based on network request, or triggered by some condition e.g. the measurement status (L1/L3 measurements performed or not performed), measurement result to be reported etc.
   The evaluation may be performed either before the cell switch command to cover one or more candidate cells, or based on the cell switch command only for the target cell.
   The evaluation may be performed for a subset of (i.e., down selected) network indicated or, UE selected cells (based on RRC configuration)
3. The UE reports the expected HO delay to the network in L1 measurement report, L3 measurement report or another message:
   a. For each candidate cell
   b. For each candidate cell the UE has performed measurements on (L1 measurements, L3 measurements)
   c. Based on the network request in step 1
   d. For the target cell in the cell switch command
   e. A further condition (RSRP-based, evaluated HO delay based etc.)

UE may report the expected HO delay as:
Exact value in ms (with a suitable granularity: e.g., 1, 2, 3, 10, 20, 50, 100, 0).
A value out of a predefined selection (e.g. less than X ms, less than X+Y ms etc.)
Index to a value, or value range in a table, for example
Offset value (e.g., baseline value 20 ms, UE indicates+/−x ms delay from that offset)
a binary value (e.g. inside or outside a range of allowed handover delays).

FIGS. 3A and 3B shows tables indicating examples of index mapped to delay values in a mapping table. The values can be specified in RRC signalling, or they can be hard-coded system specifications.

The delay value can be associated with a candidateId or PCI, or a value derived from one of the above mentioned, or another cell identifier. For example, a delay can be: (candidateId, delay). Similarly the association can be based on ordered list where delay value corresponds to a cellId in another list.

FIGS. 4 to 6 show signalling diagrams. In these signalling diagrams different possible options of embodiments are shown. In one scenario the UE performs expected HO delay evaluation based on the candidate cell configuration for all or a subset of candidate cells. The evaluation may be based on network request or done as a default. The steps that are related to embodiments are explained below.

FIG. 4 shows a signalling diagram of signals sent between a UE, a source or serving network node and a target network node during a LTM procedure.

Initially there is a preparation phase, where the UE sends L3 measurements to the serving node. The serving node prepares a set of candidate cell configurations that it sends to the UE in step 2. In the LTM candidate cell configuration, the network may request the UE to perform expected HO delay evaluation for all or a subset of candidate cells. This can also/alternatively be done in a separate message, not shown in the signalling diagram.

The UE then performs the evaluation based on the request or if there is no request, UE may perform the evaluation as a default.

The signalling diagram then shows a set of options Step 3, 4, 5, 6 of different ways in which the UE may report the results of the HO delay evaluation.

In these steps the UE indicates the result of the expected HO delay evaluation for all or a subset of the candidate cells in:
Option 1 (step 3): RRC reconfiguration complete message
Option 2 (step 4): UE assistance information
Option 3 (step 5): L1 measurement report
Option 4 (step 6): L3 measurement report
Option 5 (not shown): MAC CE control element
Option 6 (not shown): Uplink control information

In the signalling diagram random access is done after the cell switch, but it may also be done before the cell switch command based on PDCCH (physical downlink control channel) order, if configured.

FIG. 5 shows another possible option of an example embodiment. In this scenario the UE performs expected HO delay evaluation based on the cell switch command only for the indicated target LTM candidate cell. The evaluation may be based on a network request or done as a default. This allows the network to know when to schedule the target cell and may be useful where the network selects a target cell based only on signal strength measurements and delays vary significantly between cells.

The steps performed during the LTM execution are described below. The UE transmits L1/L3 measurement reports at step 4 and a HO decision is made. At Step 5 an LTM cell switch command is sent from the network, the network may request within this command that the UE to perform an expected HO delay evaluation for all or a subset of the candidate cells.

The UE performs the evaluation based on the request or if there is no request, UE may perform the evaluation as a default when receiving the cell switch command. At Step 6: The UE indicates the result of the expected HO delay evaluation for the target cell and signals this to the network. The handover is then performed and the different time delays for the steps taken during the handover are shown.

In addition to the examples shown in FIGS. 4 and 5, the UE may evaluate and/or indicate the expected HO delay to the network based also on other triggers e.g.
when one or more cells are detected
when L1 or L3 measurement is completed for reporting on one or more cells
based on measurement results e.g. RSRP is over a threshold or any other existing or new event trigger

The options given in FIG. 4 may be used for reporting the results of the evaluation.

FIG. 6 shows an example of network behaviour upon receiving the HO delay indication.

The network receives the delay information from UE in different possible formats mentioned above.

Initially UE performs HO delay evaluation of the candidate cells.

The UE then transmits HO delay evaluation results to the network (as described above).

Then the Network processes the delay results per cell
For example, the network receives the delay value from the UE and compares the delay to a threshold. Depending on the network entity configuration, if the delay value is less or greater than (equal) of the threshold, the network either triggers or not trigger a subsequent action.
   Option 1: The network modifies the candidate cell list (candidateId) based on the delay values indicated. Upon processing the HO delay indication, the network triggers RRCReconfiguration message which adds/modifies/deletes candidate cells or modifies the measurement configuration.
   Option 2: Network decides not to perform the cells switch on candidate cell where UE has indicated, and network has evaluated that the (candidateId, delay) exceeds a threshold value. Network may wait for UE to transmit subsequent measurement or HO delay values and re-evaluate the decision upon receiving new delay values.
   Option 3: Network decides to trigger L3 handover instead of LTM when the delay>threshold. The threshold can be, for example Threshold=½ L3 handover delay or when the delay is equal or exceeds the L3 handover delay.
   Option 4: (nonexclusive to others). Network entity receiving the HO message (e.g. via RRC) forwards the delay information to the entity performing HO decision. This can be done when the receiving entity first evaluates whether delay value>threshold. Alternatively, the forwarding can be blind, and the deciding entity performs the evaluation.

Network may trigger cell switch on candidateId when delay<=threshold value. This may also trigger an indication towards the target cell carrying the delay as an indication. The target cell may then start a wait process, and wait until the cell switch is triggered and UE has appeared on the target cell.

According to different embodiments the network may use the expected delay time in its target cell decision. In some cases, where low latency is important it may determine which of the candidate cells meet signal strength requirements from the L1 and/or L3 measurements and may then select the candidate cells meeting this requirement that has the lowest expected delay time. Alternatively, where signal quality is important it may select a set of potential candidate cells where the delay value is less than a threshold (e.g. a certain minimum delay) and may then select the candidate cell with the highest signal measurement. Alternatively, both of these factors may be inputs to the decision, with each factor weighted according to circumstance and with thresholds eliminating candidate cells (with too low signal measurements or too high delays) from the selection process.

FIG. 7 shows a UE 10, a source network node 20 and a candidate network node 22 according to an embodiment. Network node 20 supports providing radio coverage in a cell 30 and may comprise a distributed unit of a gNB, which communicates with a central unit 40. Alternatively, network node 20 may comprise a base station, or a femto network node . . . .

UE 10 comprises monitoring circuitry 18 for monitoring the power and/or quality of links between the UE 10 and neighbouring candidate cells 32 supported by other network nodes 22. UE 10 also comprises a data store 12 for storing candidate cell configuration information received from the network node 20, delay evaluating circuitry 14 for estimating an expected handover delay for a particular candidate cell and mobility control circuitry 17 for controlling switching between cells.

There is also transmitting and receiving circuitry 16 for transmitting and receiving messages comprising information and data to a network node 20. These messages may include L1/L3 measurement reports generated by monitoring circuitry 18 indicating the quality and/or power of links to one or more neighbouring cells and they may include one or more indications of expected handover delay estimated by delay evaluating circuitry 14.

Network node 20 comprises a data store 22, transmitting and receiving circuitry 26 for transmitting and receiving messages with the user equipment 10, and in some cases the central unit 40 and a target network node. There is determining circuitry 24 for determining neighbouring cells for which locally triggered mobility may be appropriate and for preparing these candidate cells. Message generation circuitry 25 generates a message comprising configuration information for the multiple candidate cells identified by circuitry 24.

Transmitting and receiving circuitry 26 transmits these messages to the UE. Transmitting and receiving circuitry 26 also receives from the UE 10, measurements indicating signal strengths of the different candidate cells and an indication of handover delays.

The network comprises mobility control circuitry 24, 44 that may determine from the received signals if a handover is to be performed. In some embodiments this is circuitry 24 within network node 20, while in others where network node 20 is a distributed unit of a gNB for example, then it may be circuitry 44 within central unit 40

This circuitry may determine that certain cells with delays above a threshold should be down selected or it may decide where delays are generally high and/or signals low not to perform a handover, or to perform more measurements or to perform a L3 handover.

Where it decides to perform a handover the network may use target cell evaluating circuitry 25, 45 to determine a target cell from the candidate cells based on the L1/L3 measurements and the delays. Again this may be circuitry 25 within network node 20, or where network node 20 is a distributed unit of a gNB for example, then it may be circuitry 45 within central unit 40. The evaluating circuitry 25, 45 may be configured to only consider candidate cells with measurements above a threshold and delays below a threshold and may then select one of them as the target cell based on the shortest delay, or the strongest signal or a combination of the two.

Where the network node has determined that a cell switch is appropriate and has selected a target cell it may generate and transmit a cell switch command to the UE 10 along with an indication of the target cell. It may also transmit a target cell indication to target cell 22.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus, comprising:
at least one processor; and
at least one memory storing instructions that when executed by the at least one processor cause the apparatus at least to perform:
evaluating an expected handover delay to at least one of a plurality of candidate cells;
generating an indication of said handover delay; and
causing transmission of said indication to a network node of a serving cell.

2. An apparatus according to claim 1, wherein the apparatus is caused to perform said step of evaluating in response to at least one of the following:
receiving a request from a network node;
a predetermined point in a cell switch procedure;
a signal strength measurement status
detection of one or more cells.

3. An apparatus according to claim 1, wherein the apparatus is caused to perform said step of evaluating in response to receiving a request from said network node, said request being received within at least one of the following:
a message indicating a configuration of said candidate cells;
a message indicating a cell switch is to be performed; or
a separate dedicated request.

4. An apparatus according to claim 1, wherein the apparatus is caused to perform said step of evaluating in response to receiving a request from said network, said request indicating said at least one of said plurality of candidate cells for which said evaluating is to be performed.

5. An apparatus according to claim 1, wherein the apparatus is caused to perform said evaluating for a subset of said plurality of candidate cells.

6. An apparatus according to claim 1, wherein said apparatus is caused to:
perform said evaluating to a plurality of said plurality of candidate cells, wherein said indication comprises a handover delay to each of said plurality of said plurality of candidate cells; and
receive, from said network node in response to the transmitted indication, a handover command triggering a handover to a target cell of said plurality of said plurality of candidate cells, wherein the target cell is associated with the smallest handover delay comprised in the indication.

7. An apparatus according to claim 1, wherein said apparatus is caused to transmit said handover delay indication within at least one of the following:
a UE assistance information message;
a L1 measurement report;
a L3 measurement report;
a message indicating configuration of the candidate cells is complete;
a response to a cell switch command;
a MAC CE control element; or
uplink control information.

8. An apparatus according to claim 6, wherein said apparatus is caused to generate said handover delay indication for at least one of the following:
each candidate cell;
each candidate cell the apparatus has performed measurements on;
candidate cells indicated in a request received from said network node;
a target cell indicated in a received cell switch command;
candidate cells that satisfy at least one predetermined condition, said predetermined condition comprising a handover delay condition or a measurement condition; or
at least one candidate cell and a detected cell that is not a candidate cell.

9. An apparatus according to claim 1, wherein said apparatus is caused to transmit said handover delay indication for candidate cells that satisfy at least one predetermined condition, said at least one predetermined condition comprising said handover delay being less than a threshold value.

10. An apparatus according to claim 1, wherein said handover delay indication comprises one of the following:
a time delay value;
an indication of said delay lying in one of a plurality of predefined ranges of values;
an indication that said delay meets or does not meet a threshold value
an index indicative of a value;
an offset value.

11. An apparatus according to claim 1, wherein said apparatus comprises a user equipment.

12. An apparatus, comprising at least one processor; and at least one memory storing instructions that when executed by the at least one processor cause the apparatus at least to perform:
causing transmission to a user equipment of a plurality of candidate cell configurations, said plurality of candidate cells being potential target cells for a user equipment to handover to;
in response to receipt of at least one indication of an expected handover delay for at least one of said candidate cells, generating a message regarding said handover; and
causing transmission of said message to said user equipment.

13. An apparatus according to claim 12, wherein said message comprises at least one of the following:
a modification of said plurality of candidate cell configurations;
an indication for said user equipment to perform a layer 3, L3 handover
a cell switch indication
an indication for said user equipment to perform further measurements, or
an indication not to perform a handover.

14. An apparatus according to claim 12, said apparatus being caused to perform:
comparing a value of said at least one expected handover delay with a threshold value;
and in response to said comparing generating said message.

15. An apparatus according to claim 14, said apparatus being caused to perform:
in response to receipt of at least one measurement report indicating signal strengths of at least some of said plurality of candidate cells and to receipt of said evaluation of said handover delays for at least some of said plurality of candidate cells;
selecting a target cell from said plurality of candidate cells in dependence upon said handover delays and said measurement reports; and
generating said cell switch command as said message, said cell switch command indicating one of said candidate cells as a target cell for a handover.

16. An apparatus according to claim 12, wherein said apparatus is caused in response to receipt of said at least one indication of said expected handover delay to perform: forwarding said indication to a central unit network node; and
in response to receipt of handover information from said central unit network node to perform generating said message.

17. An apparatus according to claim 12, said apparatus being caused to perform:
generating a message requesting a user equipment to perform an evaluation of a handover delay; and
causing transmission of said message to said user equipment.

18. An apparatus comprising at least one processor; and at least one memory storing instructions that when executed by the at least one processor cause the apparatus at least to perform:
in response to receipt from a distributed unit network node of at least one indication of an expected handover delay of a user equipment generating handover information; and
causing transmission of said handover information to a distributed unit network node.

19. An apparatus according to claim 18, said apparatus being caused to perform:
comparing a value of said at least one expected handover delay with a threshold value; and in response to said comparing generating said handover information.

20. An apparatus according to claim 18, wherein in response to receipt of at least one measurement report indicating signal strengths of at least some of said plurality of candidate cells and to receipt of said evaluation of said handover delays for at least some of said plurality of candidate cells, said apparatus is caused to perform:
selecting a target cell from said plurality of candidate cells in dependence upon said handover delays and said measurement reports; and
transmitting of an indication of said selected target cell to said distributed unit as said handover information.
